(19) United States
(12) Patent Application Publication
(10) Pub. No.: US 2006/0105185 A1
(43) Pub. Date: May 18, 2006

(54) New process for preparing polyimide

(75) Inventors: Kuen Yuan Hwang, Hsinchu (TW); An Pang Tu, Hsinchu Industries District (TW); Sheng Yen Wu, Hsinchu Industries District (TW); Te Yu Lin, Hsinchu Industries District (TW)

Correspondence Address: BACON & THOMAS, PLLC, 625 SLATERS LANE, FOURTH FLOOR, ALEXANDRIA, VA, 22314, US

(73) Assignee: CHANG CHUN PLASTICS CO., LTD., Taipei (TW)

(21) Appl. No.: 11/043,135

(22) Filed: Jan. 27, 2005

(30) Foreign Application Priority Data
Nov. 12, 2004 (TW) 093134694

(51) Int. Cl. B32B 27/00

(52) U.S. Cl. 428/473.5

(57) ABSTRACT

The present invention relates to a novel process for preparing polyimide, which comprises: reacting a di-anhydride with diamine to form polyamic acid, applying or casting the polyamic acid on a substrate, evaporating the solvent contain therein to control the volatile content in the resulting polyamic acid at not more than 10 wt %, rewinding the polyamic acid-coated substrate at a tensile strength of not more than 20 kgf/cm², transferring into an oven, heating the coated substrate at a gradient temperature to cyclize the polyamic acid into polyamide, to obtain a flexible laminate having excellent appearance in good yield. According to the present process, a polyimide flexible film having excellent properties can be produced in a low cost and a high yield.

This Non-provisional application claims priority under 35 U.S.C. §119(a) on Patent Application No(s). 093134694 filed in Taiwan, Republic of China on Nov. 12, 2004, the entire contents of which are thereby incorporated by reference.

### FIELD OF THE INVENTION

The present invention relates to a new process for preparing polyimide by applying or casting polyamic acid solution on a substrate, particular to a process for preparing polyimide in a form of flexible laminate, which comprises applying or casting polyamic acid solution on a substrate, controlling the volatile content of the polyamic acid applied on a substrate in a specific range, rewinding the substrate without using a spacer, and then heating it at a gradient temperature to obtain a flexible polyimide laminate having smooth appearance in good yield.

### BACKGROUND OF THE INVENTION

Polyimide is a high heat-resistant material and has been widely used in various fields. Polyimide is not soluble in solvents, is not easily molten, and can be formed into a film from a polyamic acid solution. Alternatively, it can be used as an adhesive and an insulating material for electric wire. The polyamic acid can also be firstly shaped into a final product and then cyclized (i.e. imidized). Polyimide possesses a high heat-resistance, which can withstand various packaging conditions in semiconductor field and tolerate a metallizing temperature. It also possesses electric property and low leakage current and thus is suitable for using in high frequency wire.

Due to the above-mentioned properties, polyimide has been widely used in various fields including communication, consumer electronic products, personal digital assistor, gas separation membrane, etc. Polyimide is usually produced by applying it on metal foil such as copper foil to produce a flexible circuit board, which can then be used in notebook computers, consumer electronic products, electronic communication equipments such as mobile phones and the like.

In producing such a flexible circuit board, there usually employs the processes as follows: (1) A process comprising applying polyamic acid solution on a substrate such as metal foil or polyimide film, continuously subjecting to infrared rays irradiation or continuously passing through an oven at a temperature of above 350° C. to cyclize polyamic acid into polyimide. However, in such a process, the resultant polyimide film will warp due to the difference of the thermal expanding coefficient between metal foil and polyimide at such a high temperature. It results in poor rolling when the polyimide is wound into a roll, so that the yield is reduced. Also, the equipment required in this process is expensive. (2) A process comprising applying polyamic acid solution on a substrate such as metal foil or polyimide film, positioning knitted iron webs on both sides of the substrate, subjecting to infrared rays irradiation in a batch or passing in a batch through an oven at a temperature of above 350° C. to cyclize polyamic acid into polyimide. However, the iron webs used are often deformed at such a high temperature to result in a wrinkle polyimide film so that the yield is reduced. (3) A process comprising applying polyamic acid solution on a substrate such as metal foil or polyimide film, separating each substrate by using a releasing film or a polyimide film, subjecting to infrared rays irradiation or passing through an oven at an elevated temperature to cyclize polyamic acid into polyimide. If the cyclization in this process is carried out in the elevated temperature such as higher than 340° C., the releasing film will be molten and adhere or stick on the resultant polyimide. Therefore the appearance of the resultant polyimide film is not smooth and thus its quality and yield are reduced. If the cyclization in this process is carried out in a lower temperature, a longer reaction time is required to achieve a desired cyclizing rate, for example up to 95%, thus the yield is reduced.

In view of the above circumstances, the present inventors have conducted an investigation on the conditions of cyclization of polyamic acid into polyimide and thus completed this invention.

### SUMMARY OF THE INVENTION

The present invention provides a new process for producing polyimide, comprising reacting dianhydride with diamine to form polyamic acid, applying or casting the polyamic acid on a substrate, controlling the volatile content of the polyamic acid in not more than 10 wt. % by evaporating solvent contained therein, rolling the polyamic acid-coated substrate at a tensile strength of not more than 20 kgf/cm², and then placing it in an oven and heating at a gradient temperature to dehydrate and cyclize the polyamic acid to form polyimide having excellent appearance in a good yield.

The term “poly(amic acid)” used herein refers to a product containing both functional groups of —NH—CO— and —COOH (carboxylic functional group), which are generated from reaction of the diamine and the dianhydride.

The term “polyimide” used herein refers to a product obtained from dehydrating and cyclizing the functional group —NH—CO— with the carboxylic functional group contained in the poly(amic acid) to form polyimide. Thus, the cyclization of polyamic acid is also referred as “imidization”.

### DETAILED DESCRIPTION OF THE INVENTION

In the process for producing polyimide according to the present invention, examples of the dianhydride include, but not limit to, aromatic dianhydride, such as pyromellitic dianhydride (PMDA), 4,4-biphthalic dianhydride (BPDA), 4,4′-hexafluoroisopropylidene-diphthalic dianhydride (6FDA), 1-(trifluoromethyl)-2,3,5,6-benzenetetracarboxylic dianhydride (P3FDA), 1,4-di(trifluoromethyl)-2,3,5,6-benzene-tetracarboxylic dianhydride (P6GDA), 1-(3′,4′-dicarboxyphenyl)-1,3,3-trimethyl-indan-5,6-dicarboxylic dianhydride, 1-(3′,4′-dicarboxyphenyl)-1,3,3-trimethyl-indan-6,7-dicarboxylic dianhydride, 1-(3′,4′-dicarboxyphenyl)-3-methyl-indan-5,6-dicarboxylic dianhydride, 1-(3′,4′-dicarboxyphenyl)-3-methyl-indan-6,7-dicarboxylic dianhydride, 2,3,9,10-perylene-tetracarboxylic dianhydride, 1,4,5,8-naphthalene-tetracarboxylic dianhydride, 2,6-dichloro-naphthalene-1,4,5,8-tetracarboxylic dianhydride, 2,7-dichloro-naphthalene-1,4,5,8-tetracarboxylic dianhydride, 2,3,6,7-tetrachloro-naphthalene-2,4,5,8-tetracarboxylic dianhydride, phenanthrenc-1,8,9,10-tetracarboxylic dianhydride, 3,3,4′4′-benzophenone-tetracarboxylic dianhydride, 2,2′,3,3′-benzophenone-tetracarboxylic dianhydride, 3,3′,4′,4′-biphenyl-tetracarboxylic dianhydride, 2,2′,3,3′-biphenyl-tetracarboxylic dianhydride, 4,4′-isopropylidene-diphthalic dianhydride, 3,3′-isopropylidene-diphthalic dianhydride, 4,4′-oxy-diphthalic dianhydride, 4,4′-sulfonyl-diphthalic dianhydride, 3,3′-oxy-diphthalic dianhydride, 4,4′-methylene-diphthalic dianhydride, 4,4′-thio-diphthalic dianhydride, 4,4′-ethylidene-diphthalic dianhydride, 2,3,6,7-naphthalene-tetracarboxylic dianhydride, 1,2,4,5-naphthalene-tetracarboxylic dianhydride, 1,2,5,6-naphthalene-tetracarboxylic dianhydride, benzene-1,2,3,4-tetracarboxylic dianhydride, pyrazine-2,3,5,6-tetracarboxylic dianhydride, and a combination thereof. Among, pyromellitic dianhydride (PMDA), 4,4-biphthalic dianhydride (BPDA), 4,4′-hexafluoroisopropylidene-diphthalic dianhydride (6FDA), 1-(trifluoromethyl)-2,3,5,6-benzenetetracarboxylic dianhydride (P3FDA), 1,4-bis(trifluoromethyl)-2,3,5,6-benzenetetracarboxylic dianhydride (P6GDA) are preferable.

In the process for producing polyimide according to the present invention, examples of the diamine include, but not limit to, aromatic diamine, such as 4,4′-oxy-dianiline (ODA), 5-amino-1-(4′-amino phniyl)-1,3,3-trimethyl-indane; 6-amino-1-(4′-aminophenyl)-1,3,3-trimethyl-indane, 4,4′-methylene-bis(o-chloro-aniline), 3,3′-dichloro-dibenzidme, 3,3′-sulfonyl-dianiline, 4,4′-diamino-benzophenone, 1,5-diamino-naphthalene, bis(4-aminophenyl)diethyl silane, bis(4-aminophenyl)diphenyl silane, bis(4-aminophenyl)ethyl phosphine oxide, N-[bis(4-aminophenyl)]-N-methyl amine, N-(bis(4-aminophenyl))-N-phenyl amine, 4,4′-methylene-bis(2-methyl-aniline), 4,4′-methylene-bis-(2-methoxy-aniline), 5,5′-methylene-bis(2-aminophenol), 4,4′-methylene-bis(2-methyl-aniline), 4,4′-oxy-bis(2-methoxy-aniline), 4,4′-oxy-bis(2-chloro-aniline), 2,2′-bis(4-aminophenol), 5,5′-oxy-bis(2-aminophenol), 4,4-thio-bis(2-methyl-aniline), 4,4′-thio-bis(2-methoxy-aniline), 4,4′-thio-bis(2-chloro-aniline), 4,4′-sulfonyl-bis(2-methyl-aniline), 4,4′-sulfonyl-bis(2-ethoxy-aniline), 4,4′-sulfonyl-bis(2-chloro-aniline), 5,5′-sulfonyl-bis(2-aminophenol), 3,3′-dimethyl-4,4′-diamino-benzophenone, 3,3′-dimethoxy-4,4′-diamino-benzophenone, 3,3′-dichloro-4,4′-diamino-benzophenone, 4,4′-diamino-biphenyl, m-phenylenediamine, p-phenylene-diamine, 4,4′-methylene-dianiline, 4,4′-thio-dianiline, 4,4′-sulfonyl-dianiline, 4,4′-isopropylidene-dianiline, 3,3′-dimethyl-dibenzidine, 3,3′-dimethoxy-dibenzidine, 3,3′-dicarboxy-dibenzidine, 2,4-tolyl-diamine, 2,5-tolyl-diamine, 2,6-tolyl-diamine, m-xylyl-diamine, 2,4-diamino-5-chloro-toluene, 2,4-diamino-6-chloro-toluene, and a combination thereof. Among them, 4,4′-oxy-dianiline (ODA) is preferable.

In the process for producing polyimide according to the present invention, the reaction of the dianhydride and the diamine is preferably carried out in aprotic solvents. The solvents can be any kind of aprotic solvent as long as it is inert to the reaction. Examples of the solvent include, but not limit to, N,N-dimethylacetamide (DMAc), 1-methylpyrrolidone (NMP), N,N-dimethylformamide (DMF), tetrahydrofuran (THF), dioxane, methyl ethyl ketone (MEK), chloroform (CHCl₃), methylene chloride, and the like. Among them, 1-methylpyrrolidone (NMP) and N,N-dimethylacetamide (DMAc) are preferred.

The reaction of the dianhydride and the diamine is preferably carried out at a temperature of from ambient temperature to 70° C., and the equivalent ratio of the diamine to the dianhydride is in a range of from 0.5 to 2, preferably in a range of from 0.75 to 1.25.

According to the present process for producing polyimide, after reacting dianhydride and diamine to form polyamic acid, the polyamic acid is applied or cast on a substrate and the solvent contained therein is removed to control the volatile content in the resulting polyamic acid at not more than 10%. Subsequently, by using a rewinding machine, the polyamic acid-coated substrate is wound round the steel tube of the rewinding machine at a tensile strength of not more than 20 kgf/cm², in such a manner that the side coated with polyamic acid is outward or inward. Then the wound substrate is wound off but still remained as a roll to leave a space between each layer and allow hot air flowing sufficiently over the layers to subject to cyclization. In the process of the present invention, the substrate is used in a length of up to 150 meters, preferably in a length of from 20 to 120 meters.

In the process of the present invention, the thickness of the polyamic acid applied on a substrate is not critical, as long as the volatile content in the resulting polyamic acid after coating on the substrate and before cyclization is controlled in the above range. However, in practice, the thickness is normally used in a range of from 10 μm to 100 μm, preferable in a range of from 12.5 μm to 50 μm, depending on the final use of the polyimide film.

According to the present process for producing polyimide, examples of the substrate include, for example, a polyimide film such as Kapton® polyimide film supplied by E.I. du Pont de Nemorus and Company, U.S.A. and Upliex® supplied by UBE Industries, Japan, and a metal foil such as copper foil, aluminum foil, stainless steel foil, nickel foil, and the like. The copper foil is most preferable.

Subsequently, the substrate roll is transferred to an oven which is controlled at a gradient temperature in a range of from 100 to 380° C., i.e. it starts at 100° C. and gradually increases to 380° C. in a rate of 1-2° C./min. and then cool down. During increasing temperature from 100 to 380° C., certain temperatures are maintained for several tens minutes. For example, the temperature is increased from 160° C. to 180° C. at a rate of 2° C./min and maintained at 180° C. for 30 minutes, then increased from 180 to 210° C. (or 230° C.) at a rate of 2° C./min and maintained at 210° C. (or 230° C.) for 30 minutes, and then increased from 210° C. (or 230) to 270° C. (or 290° C.) at a rate of 2° C./min and maintained at 270° C. (or 290° C.) for 30 minutes, and then further increased from 270° C. (or 290° C.) to 340° C. (or 350° C.) at a rate of 2° C./min and maintained at 340° C. (or 350° C.) for 30 minutes, and finally increased to 370° C. and maintained at the same temperature for further 30 minutes, and then cooled down.

During the cyclization reaction of polyamic acid of the present invention, catalysts are optional used to accelerate the cyclization reaction. If catalysts are used in the cyclization reaction, the heating temperature could be lower than that without using catalyst.

If the substrate used is a copper foil, to avoid the oxidation of copper, it preferably blows inert gas such nitrogen gas into the oven during the heating cyclization to maintain the oxygen concentration less than 1.0 volume %, more preferably less than 0.5 volume %, most preferably less than 0.1 volume % so that discoloration of copper attributed to its oxidation could be avoided.

In the process for producing polyimide of the present invention, in order to obtain a gap between layers of the roll substrate to allow hot air passing through the gap, shafts could be inserted into the space between layers of the roll substrate. After completing the winding procedure, the shafts are removed.

According to the process for producing polyimide of the present invention, a flexible polyimide film backing with a metal foil can be produced in a high yield at high cyclization rate. The produced polyimide film has a smooth appearance and possesses excellent mechanical properties.

The present invention will be further illustrated by the following Examples and Comparative Examples. In the following Examples and Comparative Examples, methods for determining volatile content of the polyamic acid applied on a substrate and its cyclization rate are as follows.

Method for Determining Volatile Content of the Polyamic Acid Applied on a Substrate

Metal foil coated with resin (i.e. polyamic acid solution) is cut into samples having a size of 10 cm×10 cm and weighted accurately as W1. The samples are placed in an oven at a temperature of 220° C. for 20 minutes, removed from the oven and then weighted again as W2. Separately, a 10 cm×10 cm of the same metal foil without resin is weighted as W3. The volatile content of the polyamic acid applied on a substrate is calculated from the following equation:
Volatile content (%)=(W1−W2)/(W1−W)*100%
Method for Determining Cyclization Rate (Imidization Rate) of Polyamic Acid

Absorbance peaks areas of resin (polyamic acid) at wavenumbers of 1720cm⁻¹ and 1500 cm⁻¹ is measured by using Fourier Transform Infrared Spectroscopy (FTIR) to obtain a peak ratio ([Area_{(1720cm-1)}/area_{(1500cm-1)}]_{T}), subsequently, the resin is placed in an oven at a temperature of 350° C. for 1 hour and then similarly measure its absorbance peaks areas at wavenumbers of 1720 cm⁻¹ and 1500 cm⁻¹ to obtain a peak ratio ([Area_{(1720cm-1)}/area_{(1500 cm-1)}]_{350° C.}). The cyclization rate is caculated from the following equation:
Cyclization rate (%)=([Area_{(1720cm-1)}/area_{(1500 cm-1)}]_{T}/[Area_{(1720cm-1)}/area_{(1500cm-1)}]_{350° C.})*100%

### EXAMPLE 1

4,4′-Oxy-dianiline (ODA) was reacted with pyromellitic dianhydride (PMDA) in a solvent 1-methylpyrrolidone at an equivalent ratio (diamine/dianhydride) of 0.75 to obtain polyamic acid resin solution having a solid content of 15 wt %. The resultant polyamic acid resin solution was coated in a thickness of 25 μm on a copper foil having a dimension of 18 μm thick×520 mm width by using a roller coater. Solvent NMP contained in the resin-coated copper foil was evaporated by using hot air or an IR oven until the volatile content in the resin was 3.2 wt %. The resin-coated copper foil was wound round the steel tube of a rewinding machine by controlling the tensile strength at not more than 20 kgf/cm², in such a manner that the side coated with polyamic acid was inward. During the winding, a shaft was inserted into the space between each layer of the roll substrate per 15 m. After completing the winding, the outer layer was fixed by a polyimide tape and the shafts were removed to wind off the resin-coated copper foil but still remain as a roll. Then, the resin-coated copper foil roll was transferred to an oven where nitrogen gas was blown to control oxygen content at below 0.1 volume %. A heating schedule of the oven was set as the following gradient temperatures:
1. Increasing to 180° C. and maintain for 30 minutes. Then increasing to 220° C. over 30 minutes.
2. Maintaining at 220° C. for 30 minutes. Then increasing to 280° C. over 30 minutes.
3. Maintaining at 280° C. for 30 minutes. Then increasing to 350° C. over 30 minutes.
4. Maintaining at 350° C. for 30 minutes. Then increasing to 370° C. over 10 minutes.
5. Maintaining at 370° C. for 10 minutes then cooling down.

Subsequently, the cyclization rate of the resin coated on copper foil was determined according to the above method and was observed its appearance. The results were shown in Table 1.

### EXAMPLE 2

4,4′-Oxy-dianiline (ODA) was reacted with pyromellitic dianhydride (PMDA) in a solvent 1-methylpyrrolidone at an equivalent ratio (diamine/dianhydride) of 0.75 to obtain polyamic acid resin solution having a solid content of 15 wt %. The resultant polyamic acid resin solution was added with triethylamine and acetic anhydride as catalysts and then coated in a thickness of 25 μm on a copper foil having a dimension of 18 μm thick×520 mm width by using a roller coater. Solvent NMP contained in the resin-coated copper foil was evaporated by using hot air or an IR oven until the volatile content in the resin was 5.3 wt %. The resin-coated copper foil was wound round the steel tube of a rewinding machine by controlling the tensile strength at not more than 20 kgf/cm², in such a manner that the side coated with polyamic acid was inward. During the winding, a shaft was inserted into the space between each layer of the roll substrate per 15 m. After completing the winding, the outer layer was fixed by a polyimide tape and the shafts were removed to wind off the resin-coated copper foil but still remain as a roll. Then, the resin-coated copper foil roll was transferred to an oven where nitrogen gas was blown to control oxygen content at below 0.1 volume %. A heating schedule of the oven was set as the following gradient temperatures:
1. Increasing to 120° C. and maintain for 30 minutes. Then increasing to 180° C. over 30 minutes.
2. Maintaining at 180° C. for 30 minutes. Then increasing to 250° C. over 30 minutes.
3. Maintaining at 250° C. for 30 minutes. Then increasing to 300° C. over 30 minutes.
4. Maintaining at 300° C. for 10 minutes then cooling down.

Subsequently, the cyclization rate of the resin coated on copper foil was determined according to the above method and its appearance was observed. The results were shown in Table 1.

### EXAMPLES 3 AND 4

Following the similar procedures in Example 1, except the volatile contents in the resins of Examples 3 and 4 coated on the substrate were controlled at 3.3 wt % and 3.5 wt %, respectively. Similarly, the cyclization rates of the resultant resin coated on copper foil were determined and their appearance were observed. The results were also shown in Table 1.

### COMPARATIVE EXAMPLE 1

Following the similar procedures in Example 1, except the volatile content in the resin coated on the substrate was controlled at 3.4 wt % and a 40 mesh iron wire was used as a spacer. The cyclization rate of the resin coated on copper foil was determined and its appearance was observed. The results were shown in Table 1.

### COMPARATIVE EXAMPLE 2

Following the similar procedures in Example 1, except the volatile content in the resin coated on the substrate was controlled at 3.7 wt % and an Upilex polyimide film (commercial available from UBE Industries, Japan) was used as a spacer. The cyclization rate of the resin coated on copper foil was determined and its appearance was observed. The results were shown in Table 1.

### COMPARATIVE EXAMPLE 3

Following the similar procedures in Example 1, except the volatile content in the resin coated on the substrate was controlled at 3.5 wt % and a Kapton polyimide film (commercial available from E.I. du Pont de Nemorus and Company, U.S.A.) was used as a spacer. The cyclization rate of the resin coated on copper foil was determined and its appearance was observed. The results were shown in Table 1.

### COMPARATIVE EXAMPLE 4

Following the similar procedures in Example 1, except the volatile content in the resin coated on the substrate was controlled at 11 wt %. The cyclization rate of the resin coated on copper foil was determined and its appearance was observed. The results were shown in Table 1.

TABLE 1

| | | | | | Com. | Com. | Com. | Com. |
|---|---|---|---|---|---|---|---|---|
| | Ex. 1 | Ex. 2 | Ex. 3 | Ex. 4 | Ex. 1 | Ex. 2 | Ex. 3 | Ex. 4 |
| Length of | 100 | 100 | 50 | 120 | 50 | 50 | 50 | 50 |
| copper | | | | | | | | |
| fiol(m) | | | | | | | | |
| Width of | 250 | 250 | 520 | 250 | 250 | 250 | 250 | 250 |
| copper fiol | | | | | | | | |
| (mm) | | | | | | | | |
| Spacer | None | None | None | None | 40 | Upilex | Kapton | None |
| | | | | | mesh | polyimide | polyimide | |
| | | | | | iron | film | film | |
| | | | | | wire | | | |
| Volatile | 3.2 | 5.3 | 3.3 | 3.5 | 3.4 | 3.7 | 3.5 | 11 |
| content | | | | | | | | |
| (et %) | | | | | | | | |
| Outer layer | >100% | >100% | 98% | >100% | >100% | >100% | >100% | >100% |
| cyclization | | | | | | | | |
| rate(%) | | | | | | | | |
| Inner layer | 98% | 96% | 96% | 96% | 98% | 98% | 98% | 98% |
| cyclization | | | | | | | | |
| rate (%) | | | | | | | | |
| Appearance | a) | a) | a) | a) | b) | c) | c) | d) |

Note:
a) Appearance of the resultant polyimide resin coated on copper foil was smooth without any wrinkle.
b) Wrinkle appearance of the resultant polyimide resin coated on copper foil was observed due to heat deformation of the iron wire.
c) Transverse wrinkle appearance of the resultant polyimide resin coated on copper foil was observed due to heat expansion and deformation of the spacer polyimide film.
d) The copper foil surface was stuck with resin and the appearance of the resultant resin film is poor.

From the data shown in Table 1, it demonstrates that in Examples 1-4 the present process for producing polyimide in which the volatile content in polyamic acid after applying on a substrate is controlled at not more than 10 wt % prior to proceeding cyclization can produce a ployimide film laminated on copper foil having excellent appearance without using a spacer. Contrarily, in Comparative Examples 1-3, although the volatile contents in polyamic acid after applying on a substrate are also controlled at not more than 10 wt %, but since it uses a spacer such as iron wire and polyimide film during heating and cyclizing procedures, it produces a ployimide film laminated on copper foil having wrinkle appearance attributed to thermal expansion coefficient difference between the spacer and the substrate such as cooper foil. Also, in Comparative Example 4, although it does not use a spacer during heating and cyclizing procedures, but since the volatile content in polyamic acid after applying on a substrate is controlled more than 10 wt % prior to proceeding cyclization, in heating procedure, the polyamic acid will stick on copper foil and produce a ployimide film having non-smooth appearance.

Accordingly, the novel process for producing polyimide according the present invention can produce a flexible polyimide film laminated on a substrate having smooth appearance and excellent mechanical properties in good yield at a high cyclization rate.

What is claimed is:

1. A process for producing polyimide, comprising reacting dianhydride with diamine to form polyamic acid, applying or casting the polyamic acid on a substrate, controlling the volatile content of the polyamic acid at not more than 10 wt. % by evaporating solvent contained therein, rolling the polyamic acid-coated substrate at a tensile strength of not more than 20 kgf/cm², and then placing the polyamic acid-coated substrate roll in an oven and heating at a gradient temperature to dehydrate and cyclize the polyamic acid to form polyimide film laminated on substrate.

2. The process for producing polyimide according to claim 1, wherein the cyclization of the polyamic acid is carried out optionally in the presence of a catalyst.

3. The process for producing polyimide according to claim 2, wherein the catalyst is triethylamine, acetic anhydride, or a mixture thereof.

4. The process for producing polyimide according to claim 1, wherein the substrate is a polyimide film or a metal foil selected from the group consisting of copper foil, aluminum foil, stainless steel foil, nickel foil.

5. The process for producing polyimide according to claim 4, wherein the substrate is copper foil.

6. The process for producing polyimide according to claim 5, wherein the cyclization of the polyamic acid is carried out in an inert atmosphere containing oxygen content of less than 1.0 volume %.

7. The process for producing polyimide according to claim 5, wherein the cyclization of the polyamic acid is carried out in an inert atmosphere containing oxygen content of less than 0.5 volume %.

8. The process for producing polyimide according to claim 5, wherein the cyclization of the polyamic acid is carried out in an inert atmosphere containing oxygen content of less than 0.1 volume %.
